(19) United States
(12) Patent Application Publication
(10) Pub. No.: US 2025/0091020 A1
(43) Pub. Date: Mar. 20, 2025

(54) FLUID DISTRIBUTOR AND UP-FLOW REACTORS

(71) Applicants: Koch-Glitsch, LP, Wichita, KS (US); Koch Technology Solutions, LLC, Wichita, KS (US)

(72) Inventors: Marc Michael Egbers, Hendersonville, TN (US); Sergio Escobar, Wichita, KS (US); Ahmad Syahid Fawzal, Middlesbrough (GB); Jason Carl Gause, Baytown, TX (US); Darran Matthew Headley, Valley Center, KS (US); Kenneth David Macleod, Andover, KS (US); Matthew Ray Morfin, La Porte, TX (US); Izak Nieuwoudt, Wichita, KS (US); Lynne Sharp, North Yorkshire (GB); Malcolm Seth Talbot, Duncan, OK (US)

(21) Appl. No.: 18/580,168

(22) PCT Filed: Aug. 3, 2022
(86) PCT No.: PCT/IB2022/057213

§ 371 Date: Jan. 18, 2024

Related U.S. Application Data
(60) Provisional application No. 63/228,616, filed on Aug. 3, 2021.

(51) Int. Cl. B01F 25/313; B01J 4/00; B01J 8/02

(52) U.S. Cl. CPC B01F 25/31331; B01F 25/31322; B01J 4/005; B01J 8/0242; B01J 2219/00763

(57) ABSTRACT

A fluid distributor is provided for distributing a fluid in an up-flow reactor. The fluid distributor includes a supply pipe and a plurality of fluid distribution arms that extend from the supply pipe. Each of the fluid distribution arms has a plurality of holes for discharging the fluid. An elongated hood is spaced from and at least partially surrounds each of the fluid distribution arms to redirect the fluid when discharged from the plurality of holes in the fluid distribution arms. Each hood has a plurality of holes for allowing the passage of the fluid through the hood. Each of the hoods is formed from a plurality of hood segments that positioned end to end along a length of the fluid distribution arm and have deflectors to impede the fluid from flowing between adjacent ones of the hood segments.

This application claims priority to U.S. Provisional Patent Application No. 63/228,616 filed Aug. 3, 2021, with the above-identified application being incorporated by reference herein in its entirety.

### BACKGROUND

The present invention generally relates to a fluid distributor for distributing a fluid within a mass transfer column or reactor and to an up-flow reactor that employs the fluid distributor.

Mass transfer columns are configured to contact at least two fluid streams in order to provide product streams of specific composition and/or temperature. The term “mass transfer column” as used herein is intended to encompass cross flow liquid-vapor contactors, absorbers, separators, distillation columns, divided wall columns, liquid-liquid extractors, scrubbers, and evaporators, which facilitate heat and/or mass transfer between two or more fluid phases. Some mass transfer columns, such as those used in multicomponent absorption and distillation, are configured to contact gas and liquid phases, while other mass transfer columns, like extractors, are configured to contact two liquid phases of differing density.

In some types of mass transfer columns known as reactors, chemical reactions between two or more fluid streams, sometimes facilitated by catalyst, are designed to occur. In one type of reactor, two or more fluid phases are introduced into a lower region of the reactor and flow co-currently upwardly to an upper region of the reactor where they are removed. A fixed bed of catalyst particles may be provided in the co-current flow path of the fluid streams to cause the intended catalytic reaction between the fluid streams before they are removed from the reactor.

In order to ensure good performance of the reactor, it is important to have an even distribution of both fluid streams across the cross-sectional area of the reactor as they co-currently ascend through the reactor and the catalyst bed. The heavier fluid stream, such as a liquid stream, typically enters through a nozzle at the center of the bottom head of the reactor and the lighter fluid stream, such as a gas or vapor stream, enters through a feed pipe that penetrates the wall of the reactor and connects to a distributor that is placed underneath the catalyst bed. If either of these fluid streams is not spread out over the cross-section of the reactor before they enter the catalyst bed, the desired contact of the two fluid streams within the catalyst bed is not achieved, resulting in a reduction in the performance of the reactor.

At the top of the catalyst bed the two fluid streams have to be separated to minimize the carry-over of one fluid stream into the other that may adversely affect the performance of the reactor. This carry-over is particularly problematic when the fluid streams are a liquid stream and a gas or vapor stream because the presence of carry-over gas in the liquid stream may cause cavitation that degrades the impeller of the pump that is used to withdraw the liquid phase from the reactor.

In one conventional approach to separation of the fluid streams in these types of two-phase, co-current, up-flow reactors, an impermeable disk is placed on top of chordal beams that hold a catalyst hold-down grid or baffle in place. The impermeable disk has a smaller diameter than a shell of the reactor to form an annular space for the flow of fluid between the impermeable disk and the shell. The mixed phase from the top of the catalyst bed flows around the impermeable disk, ascends through this annular space, and enters a calming zone above the impermeable disk where separation of the fluid streams is designed to occur. An intake pipe with a surrounding permeable shroud is positioned a preselected distance above the center of the impermeable disk for removal of the heavier phase from the reactor.

In order to improve the performance of these types of reactors, a need exists for improvements in the distribution of the fluid streams in the lower region of the reactor, such as before they enter the catalyst bed, and for the separation of the fluid streams in the upper region of the reactor, such as after they have ascended through the catalyst bed and prior to removal from the reactor.

### SUMMARY

In one aspect, the present invention is directed to a fluid distributor for distributing a fluid in an up-flow reactor. The fluid distributor comprises: a supply pipe and a plurality of fluid distribution arms that extend from the supply pipe, each of the fluid distribution arms having a plurality of holes for discharging the fluid when the fluid is within the fluid distribution arms and is under pressure; an elongated hood overlaying and spaced from and at least partially surrounding each of the fluid distribution arms and constructed to redirect the fluid when discharged from the plurality of holes in the fluid distribution arms, each hood having a plurality of holes for allowing the passage of the fluid through the hood, each of the hoods comprising a plurality of hood segments positioned end to end along a length of the fluid distribution arm and having deflectors to impede the fluid from flowing between adjacent ones of the hood segments.

In another aspect, the present invention is directed to a two-phase, co-current, up-flow reactor comprising: a shell defining an open internal region; a first fluid inlet and a second fluid inlet positioned in a lower region of the shell for introducing a first fluid and a second fluid, respectively, within the shell; a first fluid outlet and a second fluid outlet positioned in an upper region of the shell for removing the first fluid and the second fluid, respectively, from within the shell; a fluid distributor as described above positioned in the open internal region with the supply pipe of the fluid distributor in fluid flow communication with the first fluid inlet; a fluid distributor plate positioned above the second fluid inlet in a flow path of the second fluid when introduced within the shell through the second fluid inlet, said fluid distributor plate having a plurality of openings arranged to redistribute the second fluid across a cross section of the open internal region.

In a further aspect, the present invention is directed to a two-phase, co-current, up-flow reactor comprising: a shell defining an open internal region; a first fluid inlet and a second fluid inlet positioned in a lower region of the shell for introducing a first fluid and a second fluid, respectively, within the shell; a first fluid outlet and a second fluid outlet positioned in an upper region of the shell for removing the first fluid and the second fluid, respectively, from within the shell; spaced-apart coplanar lower support beams connected to the shell and extending chordally across the open internal region; a catalyst support grid positioned above and supported by the coplanar lower support beams; a catalyst hold-down baffle spaced above the support grid and having a central impermeable area that defines an annular flow path for the first and second fluids through the catalyst hold-down baffle in a region between the central impermeable area and an inner surface of the shell; spaced-apart coplanar upper support beams connected to the shell and extending chordally across the open internal region and supporting the catalyst hold-down baffle; an annular trough supported above the coplanar upper support beams and spaced inwardly from the inner surface of the shell for receiving the second fluid and ascending through the annular flow path; a central open region defined by the annular trough and into which the second fluid enters after overflowing the annular trough; and an intake pipe for the second fluid and having an inlet end spaced above the central impermeable area and extending upwardly to the second fluid outlet for removing the second fluid from the central open region.

### BRIEF DESCRIPTION OF THE FIGURES

In the accompanying drawings that form part of the specification and in which like reference numerals are used to indicated like components in the various views:

FIG. 1 is a bottom perspective view of a two-phase, co-current, up-flow reactor constructed in accordance with an embodiment of the present invention, with a portion of a shell of the reactor removed to show internal components;

FIG. 2 is a fragmentary, bottom perspective view of a lower region of the reactor shown in FIG. 1;

FIG. 3 is a fragmentary, top perspective view of the lower region of the reactor shown in FIG. 2;

FIG. 4 is a fragmentary, top perspective view of components shown in the lower region of the reactor in FIGS. 2 and 3, but rotated from the view shown in FIG. 3 and with a panel of a catalyst support grid removed;

FIG. 5 is a fragmentary, bottom perspective view of the catalyst support grid and a plurality of lower support beams;

FIG. 6 is a top perspective view of a fluid distributor that is also shown in FIGS. 1-4;

FIG. 7 is a fragmentary, top perspective view of an upper region of the reactor shown in FIG. 1;

FIG. 8 is a fragmentary, bottom perspective view of the upper region of the reactor shown in FIG. 7;

FIG. 9 is a fragmentary, bottom perspective view of the upper region of the reactor and similar to the view shown in FIG. 8, but with a catalyst hold-down baffle removed; and

FIG. 10 is a fragmentary, side, slightly perspective view of the upper region of the reactor shown in FIGS. 7-9 and taken in vertical section along a center plane of the reactor.

### DESCRIPTION

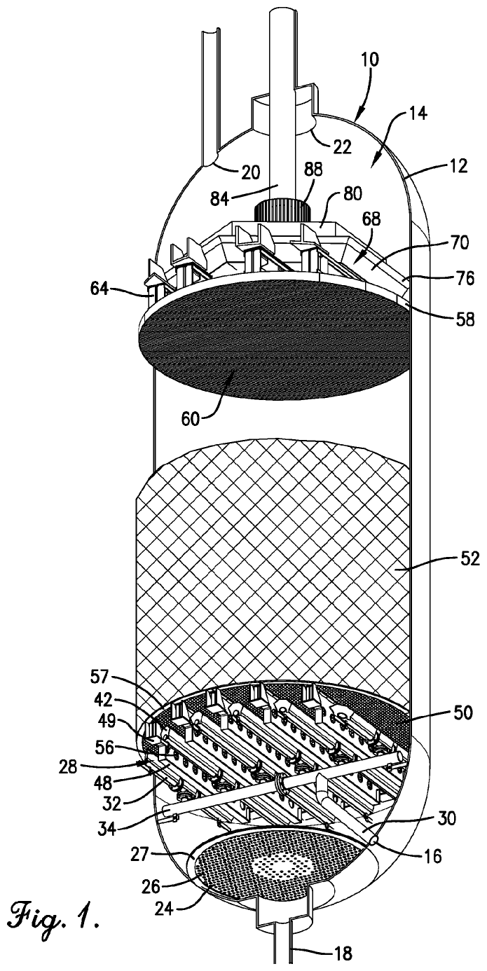

Turning now to the drawings in greater detail and initially to FIG. 1, a mass transfer column is shown in the form of a reactor that is designated generally by the number 10. In one embodiment, the reactor 10 is a two-phase, co-current, up-flow reactor, such as may be used in the dehydrogenation of 1,4-butanediol (BDO) to produce the organic solvent tetrahydrofuran (THF). THF may in turn be used to produce polytetramethylene ether glycol (PTMEG), which may be used industrially as an intermediate in the production of polyurethanes, polyesters, and polyamide elastomers.

The reactor 10 comprises an upright external shell 12 that defines a vertically extending open internal region 14 in which a catalytic or other reaction between two or more fluid streams is intended to occur. The shell 12 may have the illustrated cylindrical cross-sectional shape, or other cross-sectional shapes, such as polygonal, may be used. The shell 12 may be of any suitable diameter, thickness, and height, and is constructed of rigid materials that are inert to, or compatible with, the fluids and conditions that are present during the operation of the reactor 10.

One or more fluid streams may be introduced into the reactor 10 by way of one or more inlets, such as a first fluid inlet 16 that enters the reactor 10 through a side wall of the shell 12 and a second fluid inlet 18 that is centrally positioned in a bottom head of the shell 12. The fluid streams may both be liquid phases of different densities or, more typically, one phase is a liquid phase and the other is a gaseous or vapor phase. In one application, a gas or vapor stream enters the reactor 10 as a first fluid through the first fluid inlet 16 in the side wall of the shell 12 and a liquid stream enters the reactor 10 as a second fluid through the second fluid inlet 18 in the bottom head of the shell 12.

After ascending from a lower region to an upper region of the reactor 10, the fluid streams are removed from the reactor 10 by one or more overhead outlets, such as a first fluid outlet 20 an upper head of the shell 12 that is offset from a center axis of the shell 12 and a second fluid outlet 22 that is centrally positioned in the upper head of the shell 12. The denser fluid stream may typically be removed through the centrally positioned second fluid outlet 22 and the less dense fluid stream may be removed through the offset first fluid outlet 20.

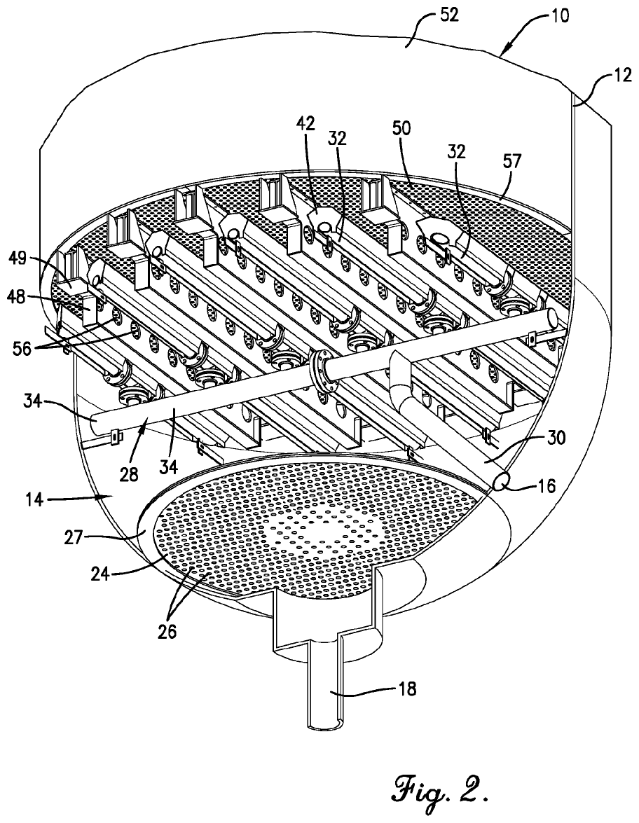

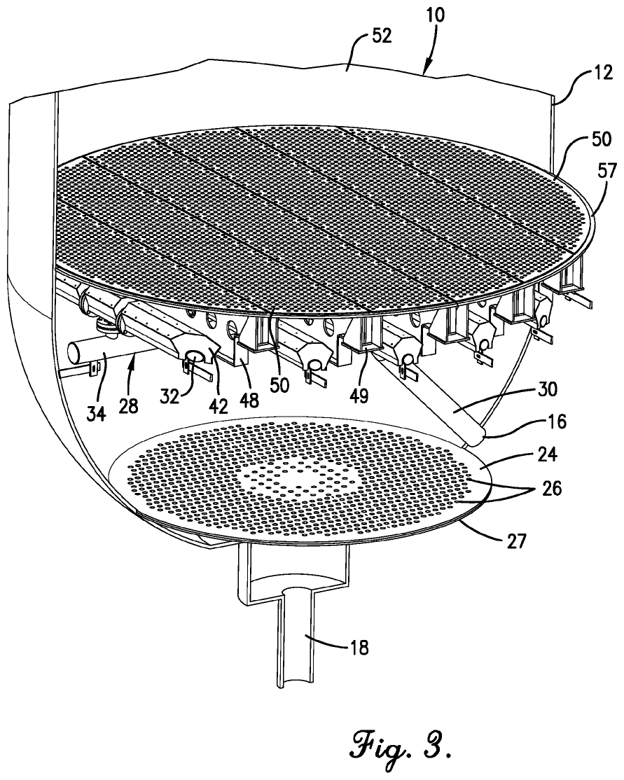

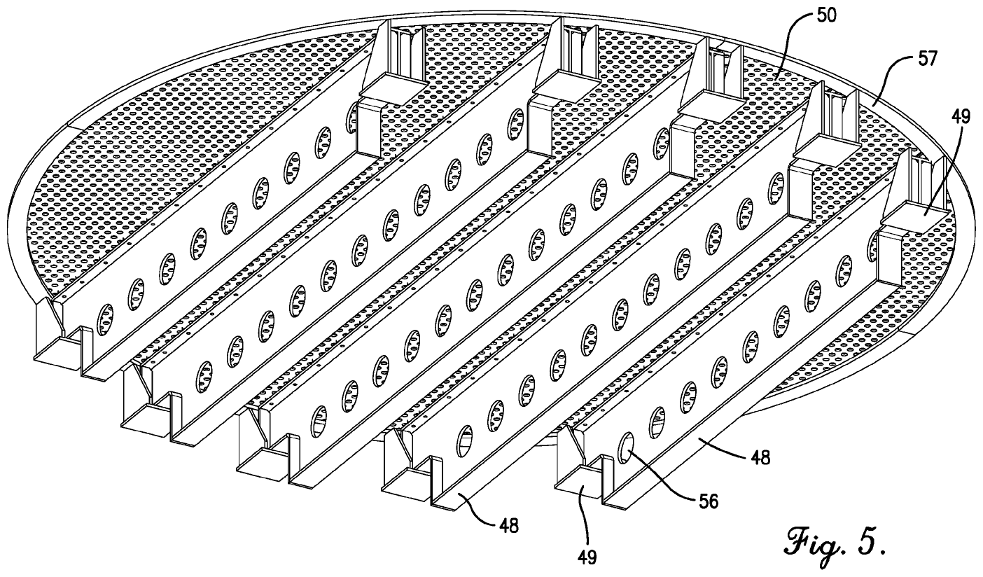

Turning additionally to FIGS. 2-6, a fluid distributor plate 24 is positioned in the open internal region 14 in the lower region of the reactor 10 above the second fluid inlet 18 in a flow path of the second fluid when it is introduced within the shell 12 through the second fluid inlet 18. The fluid distributor plate 24 has a plurality of spaced-apart openings 26 that are arranged to redistribute the second fluid across a cross section of the open internal region 14 of the shell 12 and prevent it from simply ascending along the center axis of the shell 12. In one embodiment, the openings 26 are sized and arranged so that a greater density of open area presented by the openings 26 is in areas that do not overlie the second fluid inlet 18 to facilitate the redistribution of the ascending second fluid. The openings 26 may be of various sizes and shapes and need not be of the same size and/or shape. The fluid distributor plate 24 may be secured, such as by clamping, bolting, or welding, to a support ring 27 that is attached to an inner surface of the shell 12.

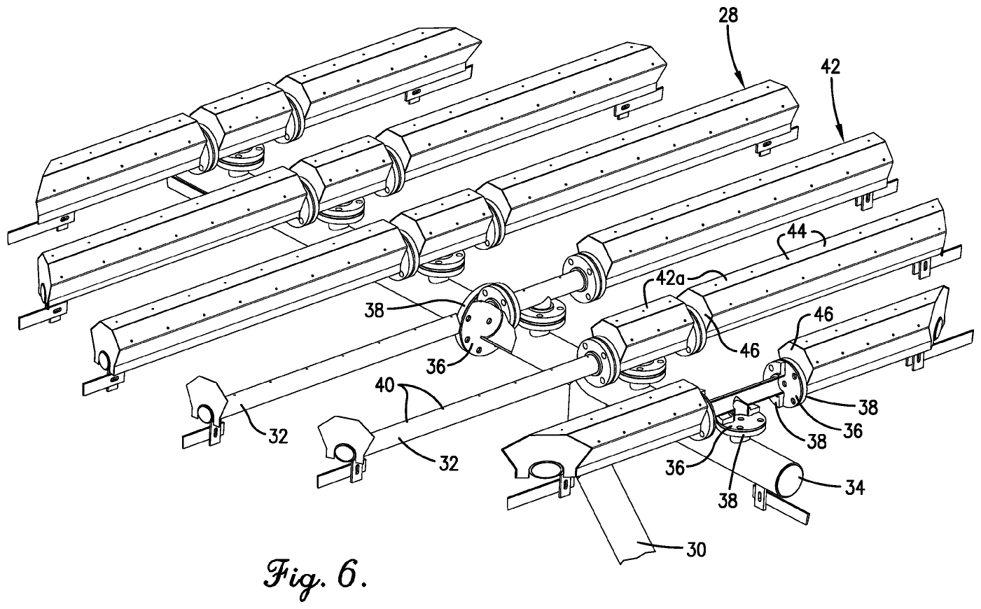

The first fluid is distributed across the cross section of the open internal region 14 of the shell 12 by a fluid distributor 28 that is spaced a preselected distance above the fluid distributor plate 24 in the lower region of the reactor 10. The structure of the fluid distributor 12 can best be seen in FIG. 6, in which portions of the fluid distributor 12 have been removed. The fluid distributor 12 comprises a supply pipe 30 and a plurality of fluid distribution arms 32 that extend from the supply pipe 30. One end of the supply pipe 30 is connected to or is otherwise in fluid flow communication with the first fluid inlet 16 in the side wall of the shell 12. The opposite end of the supply pipe 30 may be formed as a center manifold 34 that feeds individually metered volumetric flow amounts of the first fluid to each of the fluid distribution arms 32. Flow regulators may be provided to measure and control the volumetric flow of the first fluid to and through the fluid distribution arms 32 so that the desired volumetric quantity of the first fluid is provided to each fluid distribution arm 32 based on the area served by that fluid distribution arm 32. In one embodiment, the flow regulators may be orifice plates 38 mounted between flanges 40 provided in the supply pipe 30 and/or the fluid distribution arms 32. The orifices in the individual orifice plates 38 are sized to provide the desired volumetric flow of the first fluid to and through the individual fluid distribution arms 32 based on their location and flow capacity.

Each of the fluid distribution arms 32 is provided with a plurality of holes 40 for discharging the first fluid when it is within the fluid distribution arms 32 and is under pressure. The holes 40 are spaced apart along a longitudinal length of each fluid distribution arm 32. The number, size and location of the holes 40 in each fluid distribution arm 32 are selected in combination with the orifice plates 38 or other flow regulators so that the first fluid is discharged with the desired volumetric flow and placement across the cross section of the open internal region 14. Similarly, the number and orientation of the normally coplanar fluid distribution arms 32 may be selected to facilitate a more uniform distribution of the first fluid.

To counteract the tendency of the first fluid to jet out of the holes 40 in the fluid distribution arms 32, elongated hoods 42 are provided to redirect the first fluid when it is discharged from the plurality of holes 40 in the fluid distribution arms 32. The elongated hoods 40 overlay and are spaced from and at least partially surround each of the fluid distribution arms 32. Each of the elongated hoods 42 has a plurality of holes 44 that allow the passage of the first fluid through the elongated hood 42. In one embodiment, the holes 44 in the hoods 42 are not aligned with the holes 40 in the fluid distribution arms 32 so that the momentum of the first fluid is disrupted by impacting against an undersurface of the elongated hoods 42. Each of the elongated hoods 42 may be formed by multiple walls that intersect at preselected angles so that the holes 44 provided in these walls discharge the first fluid in different directions to provide a more uniform distribution of the first fluid across the cross section of the open internal region 14. In one embodiment, opposite ones of the walls that form the sides of the elongated hoods 42 have a saw-tooth lower edge (not shown) to accommodate irregularities in the interface of the first and second fluids in relation to the lower edge such as might result from misalignment of the fluid distribution arms 32.

Each of the elongated hoods 42 may comprise a plurality of individual hood segments 42a that are positioned end to end along a longitudinal length of each of the fluid distribution arms 32. Deflectors 46 are provided within each hood segment 42a to impede the first fluid from flowing between adjacent ones of the hood segments 42a, which might otherwise lead to deviation from the desired distribution of the first fluid.

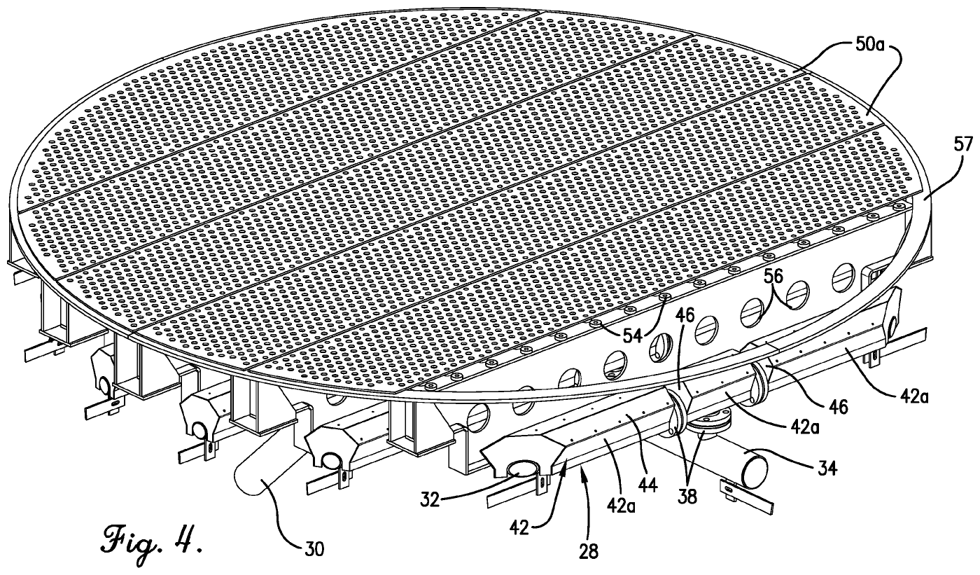

Spaced-apart and coplanar lower support beams 48 are connected to the shell 12, such as be using beam seats 49, and extend in a chordal fashion across the open internal region 14 of the shell 12. A support grid 50 is positioned above and supported by the lower support beams 48. The support grid 50 may be formed from multiple, individual support grid panels 50a (e.g., FIG. 4) that are joined together by bolting or other means. The support grid 50, in one embodiment, supports a catalyst bed 52 (shown schematically in FIG. 1) through which the first and second fluid streams ascend for catalytic reaction. The catalyst bed 52 may comprise any of various types and forms of catalyst needed for the intended catalytic reaction. In other embodiments, the support grid 50 may be used to support structured packing, random packing or other internals in addition to, or instead of, the catalyst bed 52. As shown in FIG. 4, spacers 54 may be positioned between the support grid 50 and the lower support beams 48 to create an open space for fluid flow between each lower support beam 48 and the support grid 50. The lower support beams 48 may include openings 56 to permit the fluids to flow through each of the lower support beams 48.

The lower support beams 48 and the fluid distribution arms 32 may be constructed and arranged so that the fluid distribution arms 32 extend between and extend parallel with the lower support beams 48 below the support grid 50. In one embodiment, one of the lower support beams 48 is positioned between each adjacent pair of the fluid distribution arms 32. The fluid distribution arms 32 and other parts of the fluid distributor 28 for the second fluid may be attached to the shell 12 by bolting bars or other means. The support grid 50 may be attached to the shell 12 by a support ring 57 or other means.

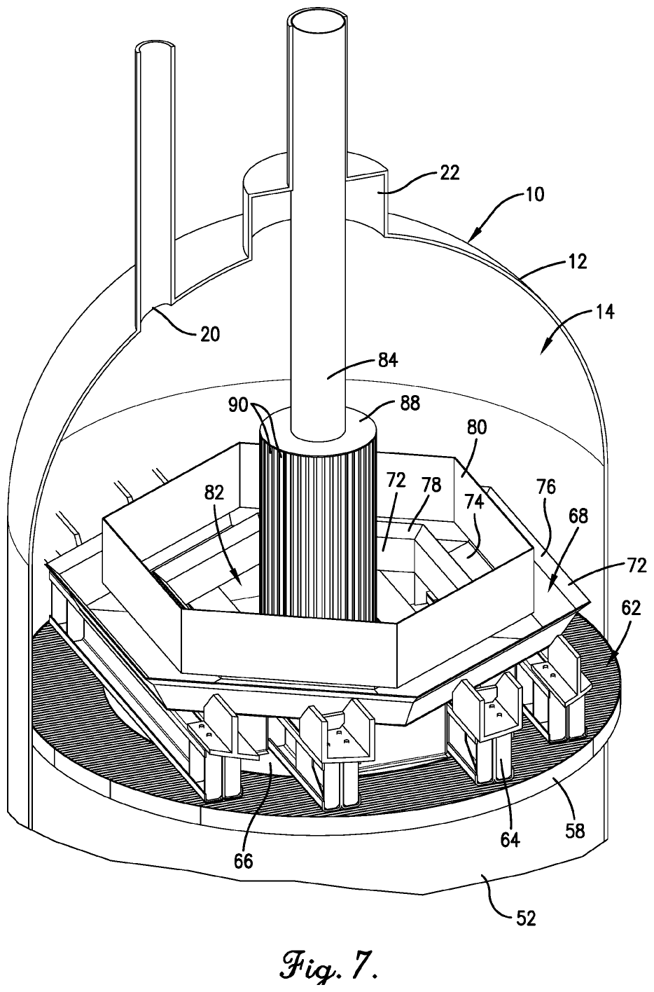

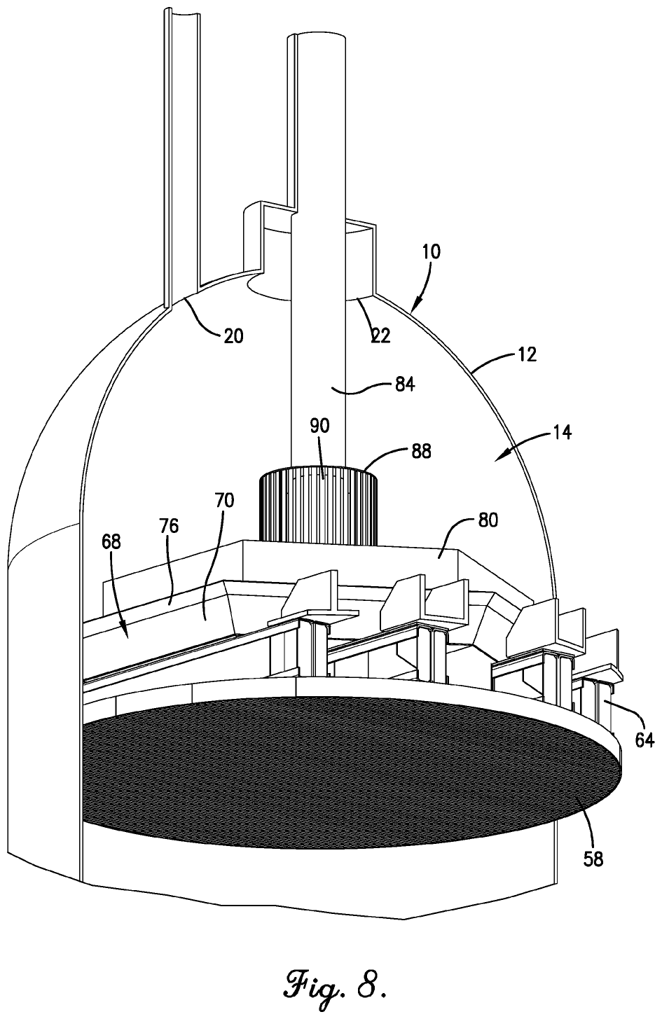

After the first fluid and the second fluid ascend as a mixture through the catalyst bed 52, they are separated in the upper portion of the open internal region 14 of the shell 12 before being removed from the reactor 10 through the first fluid outlet 20 and second fluid outlet 22, respectively. This separation is provided in part by the structures described below with reference to FIGS. 7-10 that create a tortuous path and calming zones for the flow of the first and second fluids.

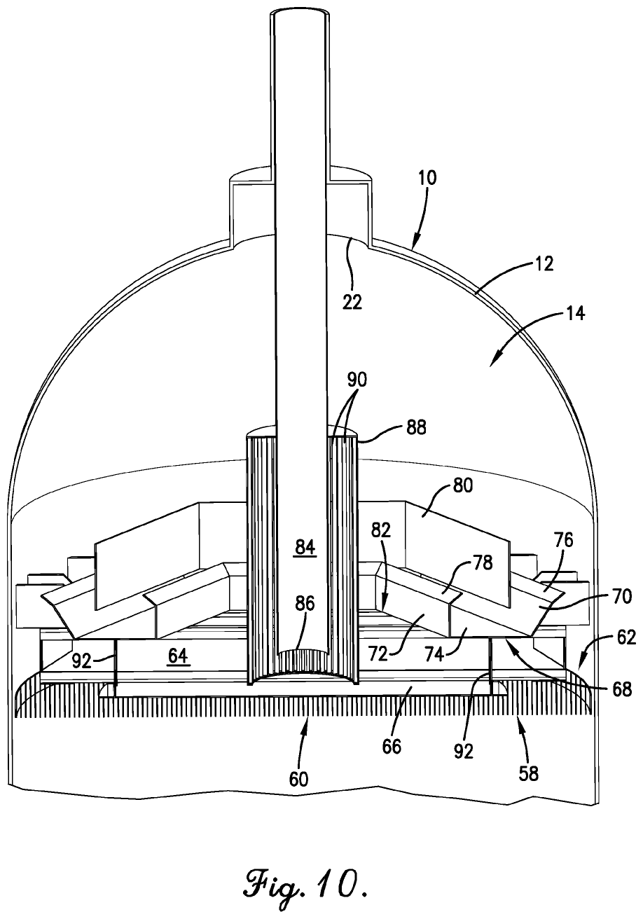

A catalyst hold-down baffle 58 is spaced above the support grid 50 and above the catalyst bed 52 (FIG. 1). As can best be seen in FIG. 10, the catalyst hold-down baffle 58 has a central impermeable area 60 that defines an annular flow path for the first and second fluids through permeable portions of the catalyst hold-down baffle 58 in an annular region 62 between the central impermeable area and an inner surface of the shell 12. Spaced-apart coplanar upper support beams 64 are connected to the shell 12 and extend chordally across the open internal region 14 and serve, in part, to support or prevent upward movement of the catalyst hold-down baffle 58. In one embodiment, the catalyst hold-down baffle 58 is positioned below the upper support beams 64.

The central impermeable area 60 may be formed by an imperforate disk 66 (FIGS. 7 and 10) that is centrally positioned on top of the catalyst hold-down baffle 58 and may be positioned between the catalyst hold-down baffle 58 and an undersurface of the upper support beams 64. The area of the imperforate disk 66 is selected to allow the annular region 62 to be of a sufficient size to accommodate the designed volumetric flow rate of the first and second fluids.

An annular trough 68 is supported above the upper support beams 64, such as by resting on an upper surface of the upper support beams 64. The annular trough 68 is spaced inwardly from the inner surface of the shell 12 a preselected distance. In one embodiment, the annular trough 68 is spaced inwardly from the inner surface of the shell 12 a sufficient distance so that it is generally in vertical alignment with an outer edge of the imperforate disk 66. The annular trough 68 comprises spaced-apart outer and inner side walls 70 and 72, respectively, and a connecting floor 74. In one embodiment, the outer side wall 70 is angled outwardly and includes a further outwardly angled lip 76 that constricts an area above the annular region 62. The inner side wall 72 may extend vertically and include a similar outwardly angled lip 78 that impedes fluid from sloshing over the inner side wall 72.

A splash baffle 80 may be positioned above the annular trough 68 for restricting the second fluid and any intermixed first fluid from jumping over the annular trough 68 and for directing it into the annular trough 80. A lower portion of the splash baffle 80 may be positioned within the annular trough 80 and an upper portion of the splash baffle 80 may extend upwardly a preselected distance above the annular trough 80. The splash baffle 80 may be annular in construction so that it is coextensive and concentric with the annular trough 80. Both the splash baffle 80 and the annular trough 68 may be formed from linear segments that are joined together to form a polygonal shape as illustrated in the drawings or they may be of a circular shape.

A central open region 82 (FIGS. 7, 9 and 10) is defined by and surrounded by the annular trough 68 and receives the second fluid and any intermixed first fluid after it overflows the annular trough 68. An intake pipe 84 for the second fluid is positioned within the central open region 82 and extends upwardly to the second fluid outlet 22 in the shell 12 for withdrawing the second fluid from the central open region 82 and the reactor 10. In one embodiment, a lower inlet end 86 (FIG. 10) of the intake pipe 84 is spaced a preselected distance above the central impermeable area 60 of the catalyst hold-down baffle 58 that is created by the imperforate disk 66. The lower inlet end 86 may extend downwardly a sufficient distance so that it is located below a plane of the floor 74 of the annular trough 68 and between adjacent ones of the upper support beams 64. At least a lower portion of the intake pipe 84 may be surrounded by a permeable shroud 88 that may facilitate separation of any of the first fluid that may remain intermixed with the second fluid before it is taken up by the intake pipe 84. In one embodiment, the shroud 88 may be formed by vertically oriented bars, such as having a triangular cross section, that are slightly spaced apart from each other to permit fluid passage.

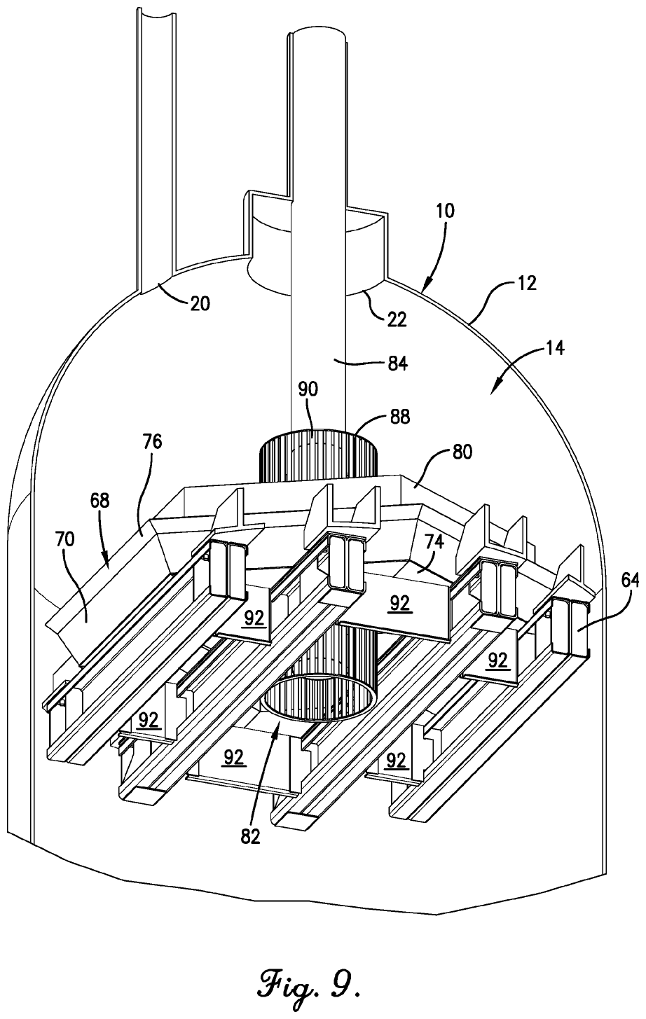

The central open region 82 may be formed as a sump, such as by using upright plates 92 (FIG. 9) that extend upwardly from the imperforate disk 66 between and joined to the upper support beams 64 to block the second fluid and any intermixed first fluid from flowing into the central open region 82 except after flowing through the annular flow path in the annular region 62 between the central impermeable area and the inner surface of the shell 12. The fluid mixture then reverses course and enters and then overflows the annular trough 68. This tortuous flow path and the calming zones formed by the annular trough 68 and the central open region 82 facilitate the separation of the lighter first fluid from the heavier second fluid and makes it difficult for the lighter first fluid to be taken up by the intake pipe 84 where it might otherwise cause cavitation damage to the impeller of the pump (not shown) that draws fluid through the intake pipe 84 or other processing equipment.

Studies using computational fluid dynamics have shown that the features of the present invention provide improvements in the distribution of the first and second fluids across the open internal region 14 of the reactor 10 and subsequent separation of the first and second fluids, which should lead to improvements in reactor performance and a reduction in degradation of downstream pumps or other processing equipment.

From the foregoing, it will be seen that this invention is one well adapted to attain all the ends and objectives hereinabove set forth, together with other advantages that are inherent to the invention.

It will be understood that certain features and subcombinations are of utility and may be employed without reference to other features and subcombinations. This is contemplated by and is within the scope of the claims.

Since many possible embodiments may be made of the invention without departing from the scope thereof, it is to be understood that all matter herein set forth or shown in the accompanying drawings is to be interpreted as illustrative and not in a limiting sense.

What is claimed is:

1. A fluid distributor for distributing a first fluid in an up-flow reactor, said fluid distributor comprising:
a supply pipe and a plurality of fluid distribution arms that extend from the supply pipe, each of the fluid distribution arms having a plurality of holes for discharging the first fluid when the first fluid is within the fluid distribution arms and is under pressure;
an elongated hood overlaying and spaced from and at least partially surrounding each of the fluid distribution arms and constructed to redirect the first fluid when discharged from the plurality of holes in the fluid distribution arms, each hood having a plurality of holes for allowing the passage of the first fluid through the hood, each of the hoods comprising a plurality of hood segments positioned end to end along a length of the fluid distribution arm and having deflectors to impede the first fluid from flowing between adjacent ones of the hood segments.

2. A two-phase, co-current, up-flow reactor comprising;
a shell defining an open internal region;
a first fluid inlet and a second fluid inlet positioned in a lower region of the shell for introducing a first fluid and a second fluid, respectively, within the shell;
a first fluid outlet and a second fluid outlet positioned in an upper region of the shell for removing the first fluid and the second fluid, respectively, from within the shell;
a fluid distributor of claim 1 positioned in the open internal region with the supply pipe of the fluid distributor in fluid flow communication with the first fluid inlet;
a fluid distributor plate positioned above the second fluid inlet in a flow path of the second fluid when introduced within the shell through the second fluid inlet, said fluid distributor plate having a plurality of openings arranged to redistribute the second fluid across a cross section of the open internal region.

3. The two-phase, co-current, up-flow reactor of claim 2, including:
spaced-apart coplanar lower support beams connected to the shell and extending chordally across the open internal region with the fluid distribution arms positioned between and extending parallel with the coplanar lower support beams; and
a support grid positioned above and supported by the coplanar lower support beams.

4. The two-phase, co-current, up-flow reactor of claim 3, including:
spacers positioned between the support grid and the coplanar lower support beams to create an open space between each coplanar lower support beam and the support grid.

5. The two-phase, co-current, up-flow reactor of claim 3, wherein each of the hoods has opposed side walls that each have a saw-tooth lower edge.

6. The two-phase, co-current, up-flow reactor of claim 3, including a catalyst supported on the support grid.

7. The two-phase, co-current, up-flow reactor of claim 3, including flow regulators in the fluid distribution arms to measure and control the flow of the first fluid through the fluid distribution arms.

8. The two-phase, co-current, up-flow reactor of claim 3, including:
a catalyst hold-down baffle spaced above the support grid and having a central impermeable area that defines an annular flow path for the first and second fluids through the catalyst hold-down baffle in a region between the central impermeable area and an inner surface of the shell;
spaced-apart coplanar upper support beams connected to the shell and extending chordally across the open internal region and supporting the catalyst hold-down baffle;
an annular trough supported above the coplanar upper support beams and spaced inwardly from the inner surface of the shell for receiving the second fluid after ascending through the annular flow path;
a central open region defined by the annular trough and into which the second fluid enters after overflowing the annular trough; and
an intake pipe for the second fluid and having an inlet end spaced above the central impermeable area and extending upwardly to the second fluid outlet for removing the second fluid from the central open region.

9. The two-phase, co-current, up-flow reactor of claim 8, including:
a splash baffle positioned above the annular trough for restricting the second fluid from jumping over the annular trough and for directing it into the annular trough.

10. The two-phase, co-current, up-flow reactor of claim 8, including:
an imperforate disk positioned on top of the catalyst hold-down baffle to form the central impermeable area.

11. The two-phase, co-current, up-flow reactor of claim 10, wherein:
the imperforate disk is positioned against an undersurface of said coplanar upper support beams and upright plates extend upwardly from the imperforate disk between the coplanar upper support beams to block the second fluid from flowing into the central open region except after flowing through the annular flow path.

12. A two-phase, co-current, up-flow reactor comprising:
a shell defining an open internal region;
a first fluid inlet and a second fluid inlet positioned in a lower region of the shell for introducing a first fluid and a second fluid, respectively, within the shell;
a first fluid outlet and a second fluid outlet positioned in an upper region of the shell for removing the first fluid and the second fluid, respectively, from within the shell;
spaced-apart coplanar lower support beams connected to the shell and extending chordally across the open internal region;
a catalyst support grid positioned above and supported by the coplanar lower support beams;
a catalyst hold-down baffle spaced above the support grid and having a central impermeable area that defines an annular flow path for the first and second fluids through the catalyst hold-down baffle in a region between the central impermeable area and an inner surface of the shell;
spaced-apart coplanar upper support beams connected to the shell and extending chordally across the open internal region and supporting the catalyst hold-down baffle;
an annular trough supported above the coplanar upper support beams and spaced inwardly from the inner surface of the shell for receiving the second fluid after ascending through the annular flow path;
a central open region defined by the annular trough and into which the second fluid enters after overflowing the annular trough; and
an intake pipe for the second fluid and having an inlet end spaced above the central impermeable area and extending upwardly to the second fluid outlet for removing the second fluid from the central open region.

13. The two-phase, co-current, up-flow reactor of claim 12, including:
a splash baffle positioned above the annular trough for restricting the second fluid from jumping over the annular trough and for directing it into the annular trough.

14. The two-phase, co-current, up-flow reactor of claim 12, including:
an imperforate disk positioned on top of the catalyst hold-down baffle to form the central impermeable area.

15. The two-phase, co-current, up-flow reactor of claim 14, wherein:
the imperforate disk is positioned against an undersurface of said coplanar upper support beams and upright plates extend upwardly from the imperforate disk between the coplanar upper support beams to block the second fluid from flowing into the central open region except after flowing through the annular flow path.

16. The two-phase, co-current, up-flow reactor of claim 14, including:
a fluid distributor of claim 1 positioned in the open internal region with the supply pipe of the fluid distributor in fluid flow communication with the first fluid inlet.

17. The two-phase, co-current, up-flow reactor of claim 16, including:
a fluid distributor plate positioned above the second fluid inlet in a flow path of the second fluid when introduced within the shell through the second fluid inlet, said fluid distributor plate having a plurality of openings arranged to redistribute the second fluid across a cross section of the open internal region.

18. The two-phase, co-current, up-flow reactor of claim 17, including:
flow regulators in the fluid distribution arms to measure and control the flow of the first fluid through the fluid distribution arms; and
spacers positioned between the support grid and the coplanar lower support beams to create an open space between each coplanar lower support beam and the support grid

19. The two-phase, co-current, up-flow reactor of claim 18, including a fluid permeable can surrounding a lower region of the intake pipe and wherein the annular trough is formed from a plurality of linear segments and includes an inlet weir.

20. The two-phase, co-current, up-flow reactor of claim 19, including a catalyst supported on the support grid.
